(19) United States
(12) Patent Application Publication
(10) Pub. No.: US 2009/0223366 A1
(43) Pub. Date: Sep. 10, 2009

(54) METHOD OF SEPARATING AND/OR PURIFYING A GAS MIXTURE

(75) Inventors: Alain Seron, Vienne en Val (FR); Fabian Delorme, Orleans (FR)

Correspondence Address: YOUNG & THOMPSON, 209 Madison Street, Suite 500, ALEXANDRIA, VA, 22314, US

(73) Assignee: BUREAU DE RECHERCHES GEOLOGIQUES ET MINIERES (B.R.G.M.), Paris (FR)

(21) Appl. No.: 12/093,715

(22) PCT Filed: Nov. 17, 2006
(86) PCT No.: PCT/FR06/02534

§ 371 Date: Sep. 22, 2008

(30) Foreign Application Priority Data
Nov. 18, 2005 (FR) 0511687

(51) Int. Cl. B01D 53/02

(52) U.S. Cl. 95/40; 95/42

(57) ABSTRACT

A method of separating/purifying a gas mixture (M), includes a step consisting in capturing at least one gas which can generate anionic species by dissolution in aqueous phase. The invention is characterised in that it also includes the following steps consisting in: suspending an absorbent product in the aforementioned aqueous phase, the absorbent product consisting of a lamellar double hydroxide or a mixed oxide which is believed to be amorphous and which originates from the moderate heat treatment of lamellar double hydroxides having an affinity for the above-mentioned gas; distributing the gas mixture (M) in the aqueous phase; and recovering the adsorbate from the absorbent product in suspension.

The present invention relates to a method for separating and/or purifying gas mixtures, some of which are able to form anionic species in an aqueous phase.

Various methods, whether they are of the physical or chemical type, are known by which separation and/or purification of gas mixtures, notably of carbon dioxide may be provided, the most widespread technique for purifying the latter being based on the use of amines and more specifically on the application of monoethanolamine solvent. This method, although of interest, has drawbacks in terms of transport because of its solvent nature. On the other hand, many impurities such as NOₓ and SOₓ poison the amines, thereby reducing the yield of the method.

Resorting to mineral traps has also been proposed, the capacity of which has been used for promoting in adequate porosity, capillary condensation of the gas. These traps notably consist of zeolites or active charcoals. A problem with this technique is however that it requires applying high temperatures and strong pressures which are necessary for forming the capillary condensation phenomenon.

A recent technique, i.e. antisublimation, was also resorted to, in which the operation occurs at atmospheric pressure by having the carbon dioxide directly pass from the vapor phase to the solid phase on the outer surface of refrigerating exchangers at temperatures comprised between 80° C. and −110° C. This method also requires applying significant power.

Finally, it was proposed to have the gas mixture, for which separation of some of the constituents is desired, flow through a membrane made in a material having a permeability which depends on the component, the isolation of which is desired during this passage. Many mineral and polymer materials were required for forming such a membrane. This technique has the drawback of only allowing low gas flow rates to be effectively treated.

The present invention as for it, in order to provide separation/purification of a gas mixture, requires lamellar double hydroxides (LDH) or mixed oxides believed to be amorphous originating from moderate heat treatment of LDHs which are either of natural or synthetic origin. Indeed, it is known that these compounds, which have many similarities with anionic clays, like the latter have: a laminar sheet-like structure, charged laminae because of isomorphic substitutions, exchangeable ions compensating charge deficiencies.

Lamellar double hydroxides, or LDHs, which are relatively rare in nature may be made by synthesis, as discussed in French Patent Application FR 05 01948 filed by the applicant company. According to this method, a synthesis of compounds of the lamellar double hydroxide type is achieved in an aqueous phase from precursor at least partly solid elements, and this by resorting to natural minerals or to industrial byproducts as precursor elements, by achieving at least partial solubilization of these precursor elements, so as to obtain a solution of divalent and trivalent cations and by achieving co-precipitation of this solution of cations with a base.

The stability of the latter, as this moreover is the case of simple hydroxides, is particularly sensitive to pH conditions, most of them only being actually stable for pHs above neutrality. It will be noted that however such stability is strongly influenced by the nature of the cations and anions present in their structure. Thus, compositions such as Cu²⁺/Cr³⁺ or N²⁺/Al³⁺ are stable at pHs much below neutrality, whereas compositions of the Ca²⁺/Al³⁺ or Mg²⁺/Al³⁺ type are only stable for pHs above 8.

It is known that the most striking properties of the compounds of lamellar double hydroxide type are directly related to their structure, and their capability is known of integrating a multitude of divalent and trivalent cations but also certain monovalent cations (such as for example Li⁺) and tetravalent cations (such as Sn⁴⁺) into this structure. Lamellar double hydroxides are also capable of adsorbing a large variety of anions, with inter-lamellar intercalation by ion exchange. Such properties are capable of finding direct applications in the field of pollution control by entrapping heavy metals such as lead, zinc, tin, and anions such as sulfates, arsenates and chromates.

The goal of the present invention is to propose a method intended to provide separation/purification of gases by means of lamellar double hydroxides, using the capability of certain gases of forming anionic species in an aqueous phase.

The object of the present invention is thus a method for separating/purifying a gas mixture (M), including a step for capturing at least one gas capable of generating anionic species by dissolution in an aqueous phase, characterized in that it includes the steps of:
suspending in said aqueous phase an adsorbent product consisting of a lamellar double hydroxide or a mixed oxide believed to be amorphous originating from moderate treatment of the LDHs having affinity for the anion originating from the dissolution of the gas to be captured;
diffusing the gas mixture (M) in the active phase,
recovering the adsorbate from the adsorbent product in suspension.

The method according to the invention preferentially includes an additional step consisting of treating by thermal means, the recovered adsorbent in order to release the gas(es) stored in the adsorbent. Chemical means, such as a diluted acid or salt solution, etching the adsorbent so as to break its structure or means capable of achieving anion displacement, may also be applied for this purpose. In order to ensure recovery of the adsorbent product, the method may then include a step for regenerating the latter, notably consisting of a treatment in a basic medium or of a heat treatment.

According to the invention, the method may include steps consisting of achieving capture of at least two gases and treating the recovered adsorbent so as to selectively release at least one gas during its desorption.

The adsorbent product may also be selected according to its affinity with the anions of said gas, the capture of which is desired inside the adsorbent.

One of the particularly interesting advantages of the present invention is that with it, it is possible to provide separation/purification at room temperature and atmospheric pressure. Further, this method is also interesting to the extent that, as discussed hereafter, it may be carried out at different levels which may be combined with each other during the process.

As a non-limiting example, various embodiments of the present invention will be described hereafter, with reference to the appended drawing wherein:

FIG. 1 is a schematic illustration of the application principle of the present invention as applied to the separation/purification of carbon dioxide.

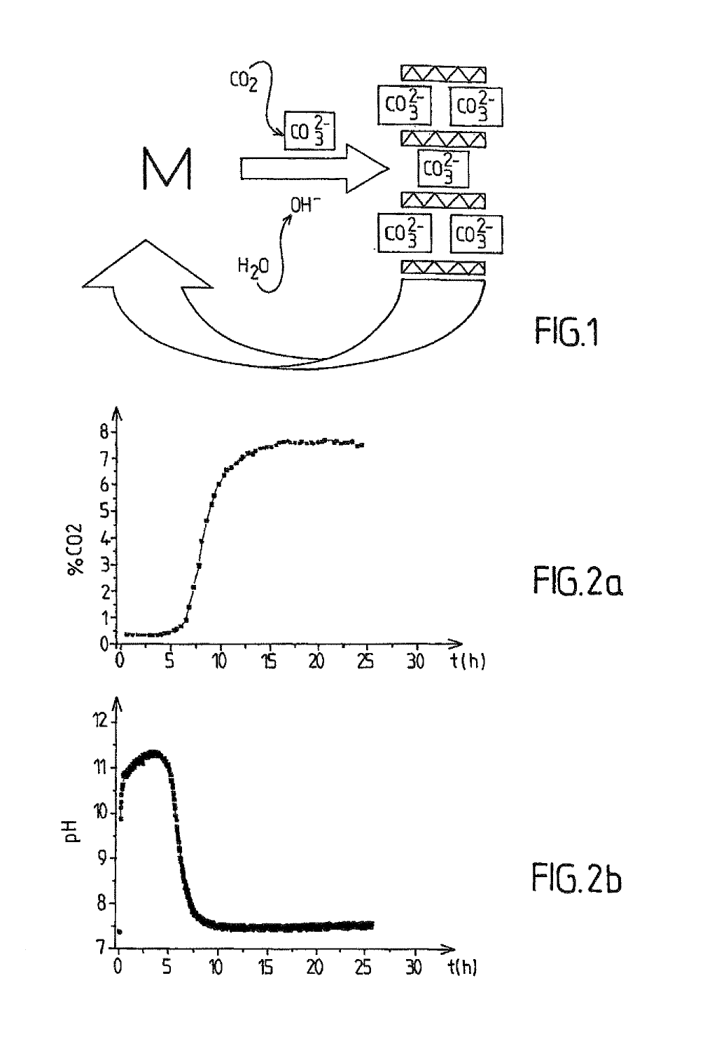

FIGS. 2a and 2b are curves versus time illustrating the change in the concentration of carbon dioxide at the reactor outlet and the pH change inside the liquid phase, respectively, when applying a method aiming at extracting carbon dioxide from a mixture of nitrogen and carbon dioxide.

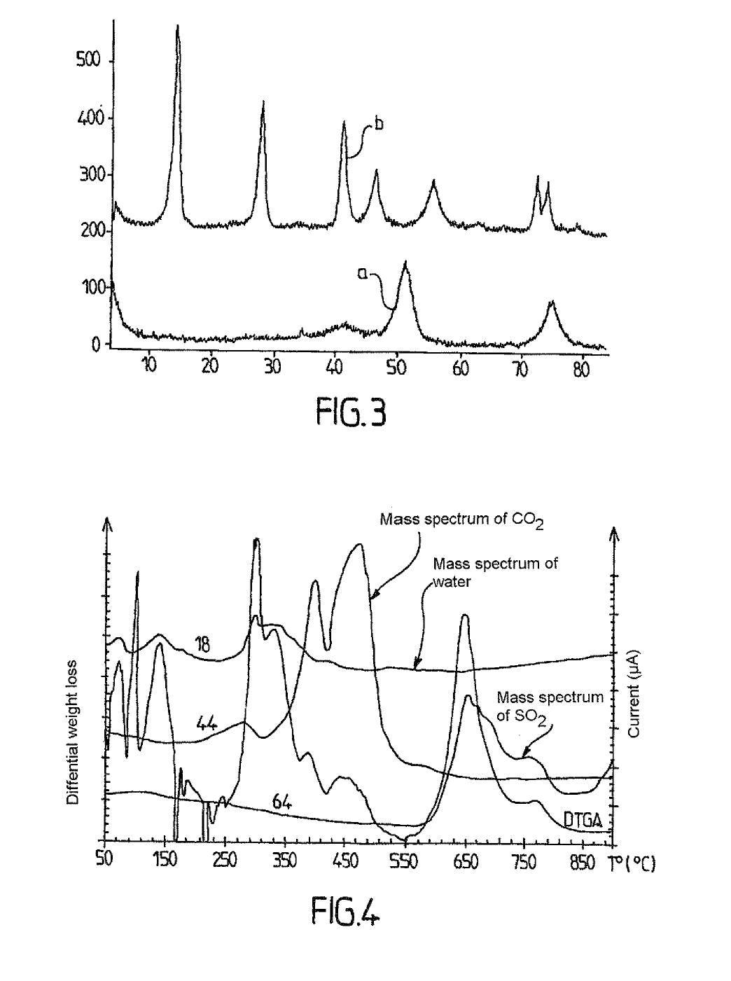

FIG. 3 illustrates two diffractograms of a mixed oxide originating from heat treatment of lamellar double hydroxides before capture on curve a) and of lamellar double hydroxides after capture on curve b), respectively.

FIG. 4 is an illustrative graph of thermogravimetric analysis associated with an analysis of the emitted gases by mass spectrometry of a sample of lamellar double hydroxides containing both sulfate and carbonate anions.

According to the invention and as schematized in FIG. 1, a mixture M of several gases is available, one of which is carbon dioxide for which extraction is desired from the mixture in a purified form. According to the invention, to do this, one resorts to an adsorbent product consisting of lamellar double hydroxides or a mixed oxide believed to be amorphous originating from a moderate heat treatment of the LDHs having the particularity of having affinity for the anions of carbon dioxide.

The adsorbent product is thereby suspended in an aqueous phase and the gas mixture M is bubbled in the latter. It is then seen that the carbonate anions CO₃²⁻ of carbon dioxide having passed into the solution, will assume a position between the laminates of the lamellar double hydroxides owing to their large affinity towards the latter. The adsorbent, i.e. the thereby charged lamellar double hydroxides, is then recovered, and one then proceeds with a treatment with which they or more specifically the carbon dioxide may be recovered in the pure gas state. This treatment, according to the relevant adsorbent product, may be a treatment of the thermal, chemical or anionic displacement type.

The separation/purification method according to the invention is of interest to the extent that it may be carried out at different levels which may be combined with each other during the process.

Indeed, a first separating level may be achieved right at the beginning of the method, at the stage of the dissolution phase. Fractionation of the gas mixture M may thereby be achieved by acting on the solubility difference of the different gases which form the latter in the aqueous phase.

At a second level, a selection may also be achieved by acting on the difference in affinity for the adsorbent product, i.e. the lamellar double hydroxide or a mixed oxide believed to be amorphous originating from moderate heat treatment of the LDHs of the different anions of the different gases which are solubilized in the aqueous phase. This anion selectivity may be modulated depending on the cation composition of the adsorbent product.

Finally, at a third level, a selection may be carried out at the end of the method by selectively controlling the release of the adsorbates during the regeneration of the adsorbents.

Moreover, and depending on the cases, the extraction and purification of a particular gas belonging to the gas mixture M may be carried out in two main ways, i.e. either by entrapping in the adsorbent product the gas, the extraction of which from the mixture is desired, and then by desorbing it, possibly in a selective way, or, conversely, by entrapping in the adsorbent product the undesirable gas species, and then by leaving the gas, the extraction of which is desired, in the released state.

As an example, an embodiment of the present invention applied to the extraction of carbon dioxide from a gas mixture M consisting of nitrogen and of carbon dioxide will be described hereafter.

### EXAMPLE I

For this purpose, a mixture of amorphous oxides, was resorted to, as an adsorbent product originating from the heat treatment of a lamellar double hydroxide of the Mg²⁺/Al³⁺ type which was suspended in water.

The mixture M of nitrogen and carbon dioxide was then bubbled in this aqueous phase. The change in the carbon dioxide concentration over time in the gas flow at the outlet of the reactor is illustrated in FIG. 2a. It is seen that for the first five hours, which correspond to the period during which the adsorbent product captures the carbonate ions CO₃²⁻, the carbon dioxide concentration decreases to a value less than 10% of its initial concentration and then increases once the adsorbent product is saturated with anions. During the initial phase (capture), as illustrated in FIG. 2b, the value of the pH strongly increases which corresponds to an increase in the basicity of the solution in accordance with the decrease in carbonate ions CO₃²⁻ in the liquid phase.

Moreover, an analysis of the adsorbent was carried out, which confirms the trapping of carbon dioxide as carbonate ions and the restructuration of the mixed oxides into crystallized lamellar double hydroxides. The carbon content as measured by a carbon analyzer shows a value of 2.50% which corresponds to the expected theoretical value for a quintinite (LDH Mg²⁺/Al³⁺/MgAl=2, CO₃²⁻ anion).

Moreover, characterization of the solid by X-ray diffraction demonstrated the restructuration of the amorphous mixed oxides into quintinite, as illustrated in FIG. 3. In the latter, curve a) represents the amorphous mixed oxides originating from the heat treatment of the lamellar double hydroxides before the entrapping, and curve b) represents the characteristic curve of the crystallized lamellar double hydroxides originating from the entrapping.

### EXAMPLE II

In the same way, it was proceeded with a mixture of carbonate, sulfate and nitrate anions in an aqueous solution representing the solution obtained after diffusion of a gas consisting of CO₂, SOₓ and NOₓ in the aqueous solution, by resorting to an adsorbent product also consisting of a mixture of amorphous oxides originating from the heat treatment of lamellar double hydroxides of the Mg²⁺/Al³⁺ type.

Moreover it was seen during tests conducted in the laboratory, that sulfate anions were moderately adsorbed by the adsorbent product, whereas nitrate anions were not. On the contrary, carbonate anions, which have strong affinity for this type of lamellar double hydroxides, were adsorbed in a large amount. The table hereafter shows the respective contents of carbon, nitrogen and sulfur in the lamellar double

TABLE

| Anions | CO₃²⁻ | NO₃² | SO₄²⁻ |
|---|---|---|---|
| Quantification | 0.1 | 0.005 | 0.2 |
| limit QL | | | |
| Content (%) | 10.8 | <QL | 1.77 |

hydroxides which have been put into contact with a mixture of CO₃²⁻, SO₄²⁻ and NO₃⁻ anions, the initial concentrations of which were 0.1M; 0.1M and 0.2M, respectively.

As mentioned earlier, a selection may also be applied during desorption of the adsorbate. Indeed, it was seen that the heat treatment of an adsorbent having trapped both sulfate ions and carbonate ions shows that the latter leave the adsorbent product at a temperature of 350° C. whereas the sulfate ions leave it at a temperature of 600° C. Indeed it is seen on the curve of FIG. 4 which illustrates the result of thermogravimetric analysis of an adsorbate containing both types of ions that the peak corresponding to the leaving of CO₂ begins around 350° C. and finishes around 500° C. whereas the leaving of SO₂ is observed between 600 and 800° C.

Desorption of the adsorbent may also be obtained by performing acid etching of the latter leading to the destruction of its hydroxylated network consequently causing salting-out of the captured ions. An advantage of the method according to the invention is that it is then possible to regenerate the adsorbent by a treatment in a basic medium or heat treatment.

1. A method for separating/purifying a gas mixture (M), including a step for capturing at least one gas capable of generating anionic species by dissolution in an aqueous phase, characterized in that it includes the steps of:
suspending in said aqueous phase an adsorbent product consisting of a lamellar double hydroxide (LDH) or a mixed oxide believed to be amorphous originating from the moderate heat treatment of the LDHs having affinity for said gas,
diffusing the gas mixture (M) in the aqueous phase,
recovering the adsorbate from the adsorbent product in suspension.

2. The method according to claim 1, characterized in that it includes a step consisting of treating the recovered adsorbent by thermal means in order to release said gas stored in the latter.

3. The method according to claim 1, characterized in that it includes a step consisting of treating the recovered adsorbent by a dilute acid or salt solution in order to achieve anionic displacement allowing release of said gas stored in the adsorbent.

4. The method according to claim 1, characterized in that it includes a step consisting of performing chemical etching of the recovered adsorbent so as to break its structure and to release said gas stored in the adsorbent.

5. The method according to claim 4, characterized in that it includes a step consisting of re-precipitating the LDHs by action of a base.

6. The method according to claim 1, characterized in that it includes steps consisting of capturing at least two gases and treating the recovered adsorbent so as to selectively release at least one gas during its desorption.

7. The method according to claim 1, characterized in that the adsorbent product is selected according to its affinity with the anions of said gas, the capture of which is desired inside said product.

8. The method according to claim 2, characterized in that it includes steps consisting of capturing at least two gases and treating the recovered adsorbent so as to selectively release at least one gas during its desorption.

9. The method according to claim 3, characterized in that it includes steps consisting of capturing at least two gases and treating the recovered adsorbent so as to selectively release at least one gas during its desorption.

10. The method according to claim 4, characterized in that it includes steps consisting of capturing at least two gases and treating the recovered adsorbent so as to selectively release at least one gas during its desorption.

11. The method according to claim 5, characterized in that it includes steps consisting of capturing at least two gases and treating the recovered adsorbent so as to selectively release at least one gas during its desorption.

12. The method according to claim 2, characterized in that the adsorbent product is selected according to its affinity with the anions of said gas, the capture of which is desired inside said product.

13. The method according to claim 3, characterized in that the adsorbent product is selected according to its affinity with the anions of said gas, the capture of which is desired inside said product.

14. The method according to claim 4, characterized in that the adsorbent product is selected according to its affinity with the anions of said gas, the capture of which is desired inside said product.

15. The method according to claim 5, characterized in that the adsorbent product is selected according to its affinity with the anions of said gas, the capture of which is desired inside said product.

16. The method according to claim 6, characterized in that the adsorbent product is selected according to its affinity with the anions of said gas, the capture of which is desired inside said product.
